(19) United States
(12) Patent Application Publication
(10) Pub. No.: US 2026/0145668 A1
(43) Pub. Date: May 28, 2026

(54) CAMERA-BASED ESTIMATION OF VEHICLE CENTER OF GRAVITY FOR MODEL-BASED VEHICLE CONTROL

(71) Applicant: GM GLOBAL TECHNOLOGY OPERATIONS LLC, DETROIT, MI (US)

(72) Inventors: Mohammadali Shahriari, Markham (CA); Hassan Askari, Thornhill (CA); Khizar Ahmad Qureshi, Pickering (CA)

(21) Appl. No.: 18/960,143

(22) Filed: Nov. 26, 2024

(51) Int. Cl. B60W 30/09; B60W 10/18; B60W 10/20; B60W 30/18; B60W 50/14; G01M 1/12; G06T 7/20; G06T 7/73

(52) U.S. Cl. CPC B60W 30/09; B60W 10/18; B60W 10/20; B60W 30/18163; B60W 50/14; G01M 1/122; G06T 7/20; G06T 7/73; B60W 2420/403; B60W 2520/06; B60W 2520/10; B60W 2520/12; B60W 2520/22; B60W 2530/201; B60W 2552/53; B60W 2710/18; B60W 2710/20; B60W 2720/10; G06T 2207/30204; G06T 2207/30256

(57) ABSTRACT

Examples described herein provide a method that includes receiving an image from a camera of a vehicle. The method further includes determining, using the image, a relative position and pose of the vehicle relative to a lane marking of a lane of a road occupied by the vehicle and in which the vehicle is traveling. The method further includes determining a relative center of gravity location of the vehicle based at least in part on the relative position and pose of the vehicle. The method further includes controlling the vehicle using an advanced driver assistance system based on a model of the vehicle, wherein the model utilizes the relative center of gravity location of the vehicle.

### BACKGROUND

The subject disclosure relates to vehicles, and in particular to camera-based estimation of vehicle center of gravity for model-based vehicle control.

Modern vehicles (e.g., a car, a motorcycle, a boat, or any other type of automobile) may be equipped with one or more cameras that provide back-up assistance, take images of the vehicle driver to determine driver drowsiness or attentiveness, provide images of the road as the vehicle is traveling for collision avoidance purposes, provide structure recognition (e.g., roadway signs, etc.), and/or the like, including combinations and/or multiples thereof. For example, a vehicle can be equipped with multiple cameras, and images from multiple cameras (referred to as “surround view cameras”) can be used to create a “surround” or “bird's eye” view of the vehicle. Some of the cameras (referred to as “long-range cameras”) can be used to capture long-range images (e.g., for object detection for collision avoidance, structure recognition, etc.).

Such vehicles can also be equipped with sensors such as a radar device(s), lidar device(s), and/or the like for perception tasks. Radar (radio detection and ranging) is a technology that uses radio waves to detect and determine the distance, speed, and angle of objects. Radar works by emitting radio signals that bounce off objects and return to the radar system, where the reflected waves are analyzed based on the amount of time between emission and reception. The measured time can be used to determine the distance between the radar device and the detected object, which can be used when performing perception tasks.

Perception tasks can include one or more of object detection, classification, tracking, lane detection, road sign recognition, and obstacle avoidance. Perception tasks are particularly useful for an autonomous or semi-autonomous vehicle to provide the vehicle with real-time awareness of its environment to make safe and informed driving decisions. Images from the one or more cameras of the vehicle can also be used for detecting objects, tracking targets, and/or the like, including combinations and/or multiples thereof.

The desire for precise vehicle control based on the center of gravity of the vehicle is important for efficient operation of the vehicle.

### SUMMARY

In one embodiment, a computer-implemented method is provided. The method includes receiving an image from a camera of a vehicle. The method further includes determining, using the image, a relative position and pose of the vehicle relative to a lane marking of a lane of a road occupied by the vehicle and in which the vehicle is traveling. The method further includes determining a relative center of gravity location of the vehicle based at least in part on the relative position and pose of the vehicle. The method further includes controlling the vehicle using an advanced driver assistance system based on a model of the vehicle, wherein the model utilizes the relative center of gravity location of the vehicle.

In addition to one or more of the features described herein, or as an alternative, further embodiments of the method may include that the vehicle is mechanically coupled to a trailer, and wherein the relative center of gravity location of the vehicle is based at least in part on the trailer.

In addition to one or more of the features described herein, or as an alternative, further embodiments of the method may include that the advanced driver assistance system is an automated lane change system to cause the vehicle to perform a lane change.

In addition to one or more of the features described herein, or as an alternative, further embodiments of the method may include that the advanced driver assistance system is a front collision alert system to generate an alert to an operator of the vehicle warning of a potential front collision.

In addition to one or more of the features described herein, or as an alternative, further embodiments of the method may include generating an alert indicating a load displacement based at least in part on the relative center of gravity location of the vehicle.

In addition to one or more of the features described herein, or as an alternative, further embodiments of the method may include that the advanced driver assistance system is a collision imminent braking system to apply brakes of the vehicle to reduce a velocity of the vehicle.

In addition to one or more of the features described herein, or as an alternative, further embodiments of the method may include that the advanced driver assistance system is an automated evasive steering system to adjust a trajectory of the vehicle.

In addition to one or more of the features described herein, or as an alternative, further embodiments of the method may include that controlling the vehicle includes performing a perception task using at least the image and the model of the vehicle that utilizes the relative center of gravity location of the vehicle.

In addition to one or more of the features described herein, or as an alternative, further embodiments of the method may include that the relative center of gravity location of the vehicle is determined using the following equation:

$${l}_{f} = \frac{( {\dot{y}}_{c} - {ψ}_{c} {v}_{x} ) L}{{v}_{x} δ}$$

where \dot{y}_{c} is a relative position to the lane marking, ψ_{c} is a relative heading of the vehicle to the lane marking, δ is a front road wheel angle of the vehicle, vₓ is a longitudinal velocity of the vehicle, L is a wheelbase of the vehicle determined by l_{f}+lᵣ, l_{f} is a distance of the relative center of gravity location to a front axle of the vehicle, and lᵣ is a distance of the relative center of gravity location to a rear axle of the vehicle.

In addition to one or more of the features described herein, or as an alternative, further embodiments of the method may include that, responsive to the vehicle being mechanically coupled to a trailer, a lateral velocity of the vehicle v_{y,c} is determined using the following equation:

$${v}_{y , c} = {v}_{x} δ \frac{{l}_{f}}{L} + {v}_{x} {θ}_{h} \frac{{l}_{t}}{{L}_{t}}$$

where θₕ is a hitch angle of the trailer relative to the vehicle.

In another embodiment, a vehicle is provided. The vehicle includes a hitch for mechanically coupling the vehicle to the trailer, a camera, and a processing system. The processing system includes a memory having computer readable instructions and a processing device for executing the computer readable instructions, the computer readable instructions controlling the processing system to perform operations. The operations include receiving an image from the camera. The operations further include determining, using the image, a relative position and pose of the vehicle and trailer relative to a lane marking of a lane of a road occupied by the vehicle and trailer and in which the vehicle and trailer are traveling. The operations further include determining a relative center of gravity location of the vehicle and trailer based at least in part on the relative position and pose of the vehicle and trailer. The operations further include controlling the vehicle using an advanced driver assistance system based on a model of the vehicle and trailer, wherein the model utilizes the relative center of gravity location of the vehicle and trailer.

In addition to one or more of the features described herein, or as an alternative, further embodiments of the vehicle may include that the advanced driver assistance system is an automated lane change system to cause the vehicle to perform a lane change.

In addition to one or more of the features described herein, or as an alternative, further embodiments of the vehicle may include that the advanced driver assistance system is a front collision alert system to generate an alert to an operator of the vehicle warning of a potential front collision.

In addition to one or more of the features described herein, or as an alternative, further embodiments of the vehicle may include that the advanced driver assistance system is a collision imminent braking system to apply brakes of the vehicle to reduce a velocity of the vehicle.

In addition to one or more of the features described herein, or as an alternative, further embodiments of the vehicle may include that the advanced driver assistance system is an automated evasive steering system to adjust a trajectory of the vehicle.

In addition to one or more of the features described herein, or as an alternative, further embodiments of the vehicle may include that controlling the vehicle includes performing a perception task using at least the image and the model of the vehicle that utilizes the relative center of gravity location of the vehicle.

In addition to one or more of the features described herein, or as an alternative, further embodiments of the vehicle may include that the relative center of gravity location of the vehicle is determined using the following equation:

$${l}_{f} = \frac{( {\dot{y}}_{c} - {ψ}_{c} {v}_{x} ) L}{{v}_{x} δ}$$

where \dot{y}_{c} is a relative position to the lane marking, ψ_{c} is a relative heading of the vehicle to the lane marking, δ is a front road wheel angle of the vehicle, vₓ is a longitudinal velocity of the vehicle, L is a wheelbase of the vehicle determined by l_{f}+lᵣ, l_{f} is a distance of the relative center of gravity location to a front axle of the vehicle, and lᵣ is a distance of the relative center of gravity location to a rear axle of the vehicle.

In addition to one or more of the features described herein, or as an alternative, further embodiments of the vehicle may include that, responsive to the vehicle being mechanically coupled to a trailer, a lateral velocity of the vehicle v_{y,c} is determined using the following equation:

$${v}_{y , c} = {v}_{x} δ \frac{{l}_{f}}{L} + {v}_{x} {θ}_{h} \frac{{l}_{t}}{{L}_{t}}$$

where θₕ is a hitch angle of the trailer relative to the vehicle.

In another embodiment a computer program product is provided. The computer program product includes a set of one or more computer-readable storage media and program instructions, collectively stored in the set of one or more storage media, for causing a processor set to perform computer operations. The operations include receiving an image from a camera of a vehicle. The operations include determining, using the image, a relative position and pose of the vehicle relative to a lane marking of a lane of a road occupied by the vehicle and in which the vehicle is traveling. The operations include determining a relative center of gravity location of the vehicle based at least in part on the relative position and pose of the vehicle. The operations include controlling the vehicle using an advanced driver assistance system based on a model of the vehicle, wherein the model utilizes the relative center of gravity location of the vehicle.

In addition to one or more of the features described herein, or as an alternative, further embodiments of the computer program product may include that the relative center of gravity location of the vehicle is determined using the following equation:

$${l}_{f} = \frac{( {\dot{y}}_{c} - {ψ}_{c} {v}_{x} ) L}{{v}_{x} δ}$$

where \dot{y}_{c} is a relative position to the lane marking, ψ_{c} is a relative heading of the vehicle to the lane marking, δ is a front road wheel angle of the vehicle, vₓ is a longitudinal velocity of the vehicle, L is a wheelbase of the vehicle determined by l_{f}+lᵣ, l_{f} is a distance of the relative center of gravity location to a front axle of the vehicle, and lᵣ is a distance of the relative center of gravity location to a rear axle of the vehicle, and
wherein, responsive to the vehicle being mechanically coupled to a trailer, a lateral velocity of the vehicle v_{y,c} is determined using the following equation:

$${v}_{y , c} = {v}_{x} δ \frac{{l}_{f}}{L} + {v}_{x} {θ}_{h} \frac{{l}_{t}}{{L}_{t}}$$

where θₕ is a hitch angle of the trailer relative to the vehicle.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 illustrates a vehicle with a processing system and camera according to one or more embodiments;

FIG. 2 illustrates the processing system of FIG. 1 according to one or more embodiments;

FIG. 3 illustrates a block diagram of a system for camera-based estimation of vehicle center of gravity for model-based vehicle control according to one or more embodiments;

FIG. 4 illustrates a schematic diagram of a system for camera-based estimation of vehicle center of gravity for model-based vehicle control according to one or more embodiments;

FIG. 5A depicts a flow diagram of a method for camera-based estimation of vehicle center of gravity for model-based vehicle control according to one or more embodiments;

FIG. 5B depicts a flow diagram of a method for camera-based estimation of vehicle center of gravity for model-based vehicle control according to one or more embodiments; and

FIG. 6 illustrates a block diagram of a processing system for camera-based estimation of vehicle center of gravity for model-based vehicle control according to one or more embodiments.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

As used herein, the term “controller” (e.g., a charging controller as further described herein) refers to a dedicated controller including a processor and a memory, a general controller including control modules configured to enact a control process using the dedicated controller, a network of multiple distinct controllers in communication with each other and each including processors and memory and being configured to cooperatively implement the control process, and any similar configuration for implementing the control process.

One or more embodiments described herein relates to camera-based estimation of vehicle center of gravity (CG) for model-based vehicle control.

Vehicles may use advanced driver assistance systems (ADASs) to improve vehicle performance and enhance driving comfort by providing automating, adapting, or enhancing vehicle systems to provide better awareness, decision-making, and control.

One example of an ADAS is an adaptive cruise control (ACC) system, which automatically adjusts the velocity of a vehicle to maintain a safe following distance from another vehicle ahead of the vehicle. Another example of an ADAS is an automated lane change (ALC) system to cause the vehicle to perform a lane change. Another example of an ADAS is a front collision alert (FCA) system to generate an alert to an operator of the vehicle warning of a potential front collision. Another example of an ADAS is a collision imminent braking (CIB) system to apply brakes of the vehicle to reduce a velocity of the vehicle. Another example of an ADS is an automated evasive steering (AES) system to adjust the trajectory of the vehicle.

ADASs often use data (referred to as “sensor data”) from sensors (e.g., RADAR sensors, LiDAR sensor, proximity sensors, etc.), images from cameras, and/or the like, including combinations and/or multiples thereof, to perform perception tasks, make decisions, and control one or more aspects of the vehicle.

Modern vehicle systems rely on advanced technologies to perform perception tasks, such as detecting, classifying, and tracking objects. These capabilities are useful for systems that enable accurate and efficient navigation, including semi-autonomous or autonomous operation of a vehicle, by understanding, in real-time, an environment of the vehicle. Challenges arise when the CG of a vehicle is unknown or shifts from a known location to an unknown location. For example, a CG of a vehicle may be known based on manufacturing specifications. However, the CG for the vehicle may change due to weight distribution changes, such as a load added to the vehicle, a trailer connected to the vehicle, and/or the like, including combinations and/or multiples thereof.

One or more embodiments described herein utilize vehicle cameras, such as those cameras associated with ADASs, to estimate a vehicle CG location for model-based vehicle control of the vehicle. According to one or more embodiments, a technique is provided for estimating or determining a vehicle's turn center and CG location using perception data (e.g., images from a camera). According to one or more embodiments, a mathematical formulation is provided for modeling vehicle motion from detected lane marks (e.g., from images from a camera) to calculate the correctness of the CG location. According to one or more embodiments, a technique is provided for systematically calculating contextual conditions that is feasible to learn the CG location for the vehicle and updating the CG parameter to correct for the suboptimal CG location.

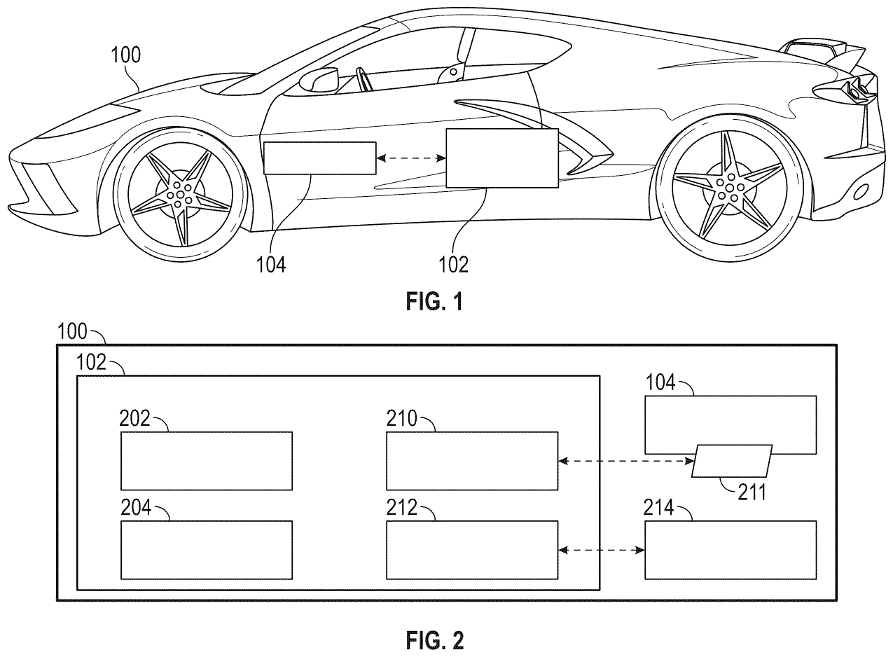

FIG. 1 shows a vehicle 100 with a processing system 102 and camera 104 according to one or more embodiments. The vehicle 100 can be a car, a truck, a van, a bus, a motorcycle, a boat, or any other type of automobile. According to an embodiment, the vehicle 100 is a hybrid electric vehicle, such as a plug-in hybrid electric vehicle (PHEV) partially or wholly powered by electrical power. According to another embodiment, the vehicle 100 is an electric vehicle powered by electrical power. A battery (not shown) is used to provide electrical power to components of the vehicle 100, such as an electric motor (not shown), electrical components (not shown), and/or the like, including combinations and/or multiples thereof. According to one or more embodiments, the vehicle 100 is an autonomous or semi-autonomous vehicle. An autonomous vehicle is a vehicle that has self-driving capabilities. A semi-autonomous vehicle is a vehicle that has certain autonomous features (e.g., self-parking, lane keeping, etc.) but lacks full autonomous control.

The processing system 102 is located within the vehicle and is responsible for managing and processing data (e.g., images) collected by the camera 104. The camera 104 is strategically positioned on the vehicle 100 to gather images of the vehicle's environment, such as a lane of travel in which the vehicle 100 is operating. The arrows between the camera 104 and the processing system 102 indicate the flow of data (e.g., images) from the camera 104 to the processing system 102, highlighting the interaction between these components. This setup enables the vehicle 100 to perform tasks perception tasks, which can be used for autonomous driving for example, using the data (e.g., images) collected by the camera 104.

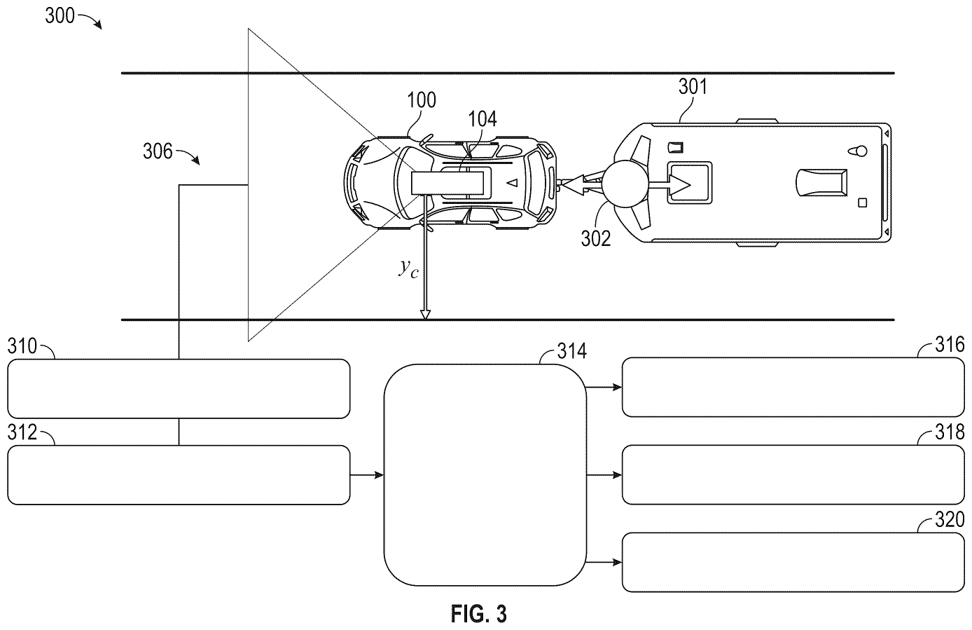

Further features of the processing system 102 and the camera 104 are now described with reference to FIG. 2.

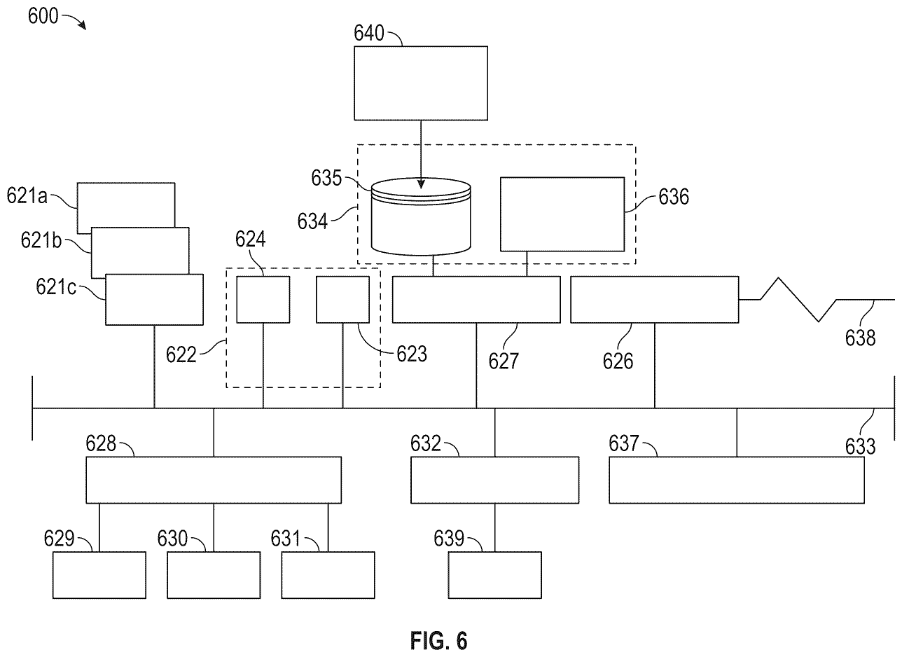

Particularly, FIG. 2 illustrates the processing system of FIG. 1 according to one or more embodiments. According to one or more embodiments, the processing system 102 includes a processing device 202, a memory 204, a CG engine 210, and a perception task engine 212. It should be appreciated that the processing system 102 can be any device suitable for camera-based estimation of vehicle center of gravity for model-based vehicle control. For example, the processing system 102 can be a device implemented in or otherwise associated with the vehicle 100, such as an electronic control unit (also referred to as an electronic control module). As another example, the processing system 102 can be a smartphone, tablet computer, laptop computer, desktop computer, wearable computing device, and/or the like, including combinations and/or multiples thereof. As yet another example, the processing system 102 can be the processing system 600 of FIG. 6 and/or can include one or more components of the processing system 600 of FIG. 6.

The processing device 202 is responsible for executing instructions and managing the overall operation of the processing system 102. The processing device 202 can be any suitable processing circuitry for executing instructions and processing data. For example, the processing device 202 can be a microcontroller, microprocessor, application-specific integrated circuit (ASIC), or any other type of processing unit capable of handling the computational demands of the processing system 102. The processing device 202 is an example of one or more of the processing devices 621 of FIG. 6, as described in more detail herein.

The memory 204 stores data (e.g., images 211), computer-readable instructions, and algorithms useful for operation of the processing system 102. This may include real-time data processing, historical data analysis, and storage of firmware or software programs. The memory 204 is any suitable device for storing data, such as the images 211, and/or instructions. For example, the memory 204 can be a combination of volatile memory (e.g., random access memory) and non-volatile memory (e.g., read-only memory, flash memory). The memory 204 is an example of one or more of the system memory 622, the random access memory 623, and/or the read-only memory 624 of FIG. 6, as described in more detail herein.

The processing system 102 receives images 211 (from the camera 104) of objects, such as a target object, in an environment in which the vehicle 100 is operating. According to one or more embodiments, the images 211 can be images of a lane in which the vehicle 100 is traveling, including any lane markers (e.g., lane lines, turn indicators, etc.) of the lane. The images 211 can be useful, for example, for performing perception tasks, which in turn are used to control the vehicle using an ADAS 214.

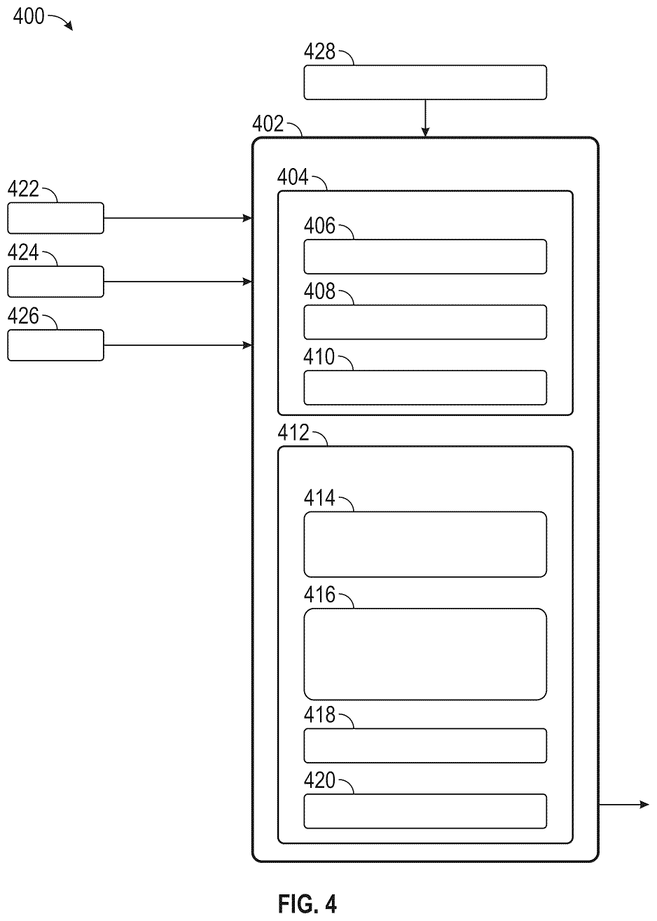

The CG engine 210 is responsible for determining a CG of the vehicle 100. To do this, the CG engine 210 uses the images 211 to measure a relative position and pose of the vehicle with respect to lane markings and then calculates the relative CG location of the vehicle based on the relative position and pose of the vehicle with respect to the lane markings. Features and functions of the CG engine 210 are further described with respect to FIGS. 3-5B.

The perception task engine 212 processes the images 211 to perform various perception tasks, such as object detection, classification, and tracking. It uses the images 211 to provide real-time awareness of the environment of the vehicle 100, including any target objects. The perception task engine 212 is useful for applications, such as autonomous driving, where accurate and timely perception is used for efficient and effective navigation. By leveraging advanced algorithms and processing techniques, the perception task engine 212 can interpret complex data sets, such as the images 211, enabling the vehicle 100 (or an operator of the vehicle 100) to make informed decisions. According to one or more embodiments, the perception task engine 212 enables the vehicle 100 to autonomously or semi-autonomously navigate through its environment with reduced need for manual intervention.

According to one or more embodiments, the perception task engine 212 can be used in combination with an autonomous driving system, such as the ADAS 214, to control autonomous navigation capabilities of the vehicle 100, allowing the vehicle 100 to navigate with respect to detected objects. According to one or more embodiments, the autonomous driving system processes information received from the perception task engine 212 and/or the images 211 received from the camera 104 to determine the precise location and orientation of the vehicle 100. The ADAS 214 then generates control signals to steer, accelerate, or brake the vehicle 100 as desired to safely and efficiently navigate the vehicle 100 within its environment. The ADAS 214 ensures that the vehicle 100 can autonomously perform complex maneuvers, reducing the need for manual intervention.

FIG. 3 illustrates a block diagram of a system 300 for camera-based estimation of vehicle center of gravity for model-based vehicle control according to one or more embodiments.

The system 300 can be implemented by a vehicle 100 equipped with a camera 104 and a processing system 102. The vehicle 100 is mechanically coupled to a trailer 301. Together, the vehicle 100 and the trailer 301 include a CG location 302 that is based on the size and weight of the vehicle 100 and the size and weight of the trailer 301.

The vehicle 100, using the processing system 102 described in FIG. 2, measures the relative position and pose of the vehicle 100 and a trailer 301 at block 310, calculates the relative CG location for the vehicle 100 and trailer 301 at block 312, and updates motion estimation for control purposes at block 314.

More particularly, at block 310, the processing system 102 measures the relative position and pose of the vehicle 100 and trailer 301 with respect to lane markings of a lane 306 in which the vehicle 100 operates. The camera 104 captures images that are processed to determine the position and pose of the vehicle 100 within the lane 306.

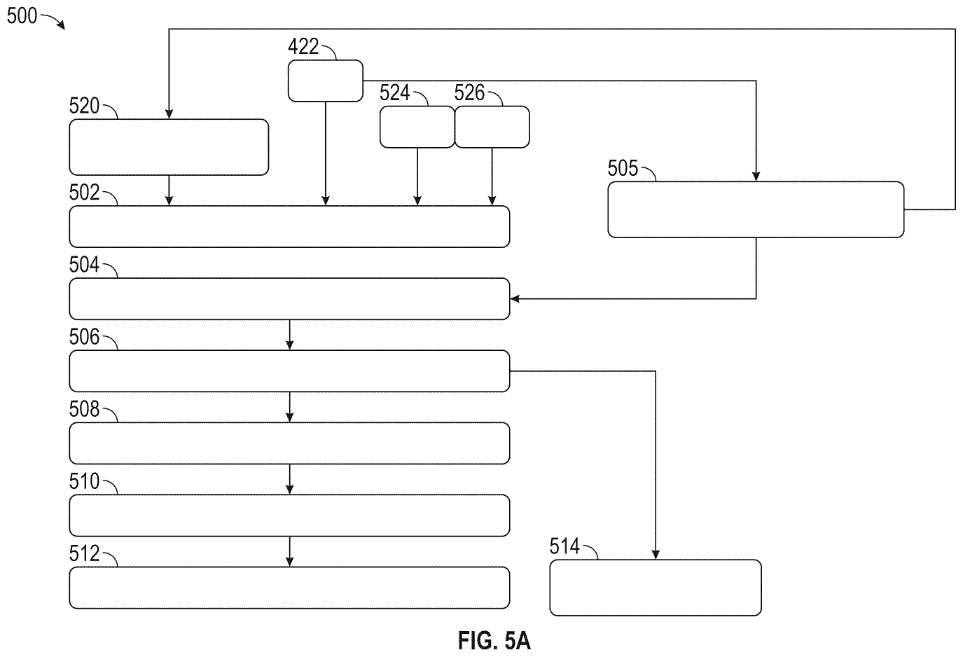

The processing system 102 first determines a velocity of the vehicle 100 using the images 211. Particularly, the processing system 102 determines a camera-based velocity v_{y,c} from lane markings given by the relative position to the lane mark \dot{y}_{c}, the relative heading of the vehicle to the lane mark ψ_{c}, and the longitudinal velocity vₓ calculated from a front camera module (e.g., FCM 422 of FIG. 4 (e.g., the camera 104)), a wheel speed sensor (e.g., WSS 424 of FIG. 4), a steering angle sensor (e.g., SAS 426 of FIG. 4), and/or an inertial measurement unit (IMU) (not shown) using the following equation:

$${v}_{y , c} = {\dot{y}}_{c} - {ψ}_{c} {v}_{x} .$$

According to one or more embodiments, in low-speed scenarios (e.g., less than 5 miles per hour), the kinematic-based velocity can be accurately estimated according to the following equation:

$${v}_{y , m} = {v}_{x} δ \frac{{l}_{f}}{L}$$

where δ is the front road wheel angle of the vehicle 100 (from the SAS 426), L is the wheelbase of the vehicle 100 determined by l_{f}+lᵣ, l_{f} is a distance of the CG location 302 to the front axle of the vehicle 100, and lᵣ is a distance of the CG location 302 to the rear axle of the vehicle 100. This same equation can be applied for a vehicle with a tailoring system (e.g., the vehicle 100 and the trailer 301) in the form of a reduced model. If vision-based hitch angle information is available (e.g., detected by the camera 104 or another suitable camera), a similar approach can be applied to estimate the lateral velocity of the vehicle 100 according to the following equation:

$${v}_{y , c} = {v}_{x} δ \frac{{l}_{f}}{L} + {v}_{x} {θ}_{h} \frac{{l}_{t}}{{L}_{t}}$$

where θₕ is the hitch angle of the trailer 301 relative to the vehicle 100.

Then, at block 312, the processing system 102 calculates the relative CG location (e.g., the CG location 302) of the vehicle 100 and trailer 301. This calculation uses the measured position and pose data from block 310 to determine the CG location 302, which is important for stability and control. For example, the CG location 302 can be determined for the vehicle (and also for the reduced model for the trailer 301) using the following equation:

$${l}_{f} = \frac{( {\dot{y}}_{c} - {ψ}_{c} {v}_{x} ) L}{{v}_{x} δ} .$$

The CG engine 210 is designed and enabled when vₓδ is greater than an error value ϵ₀ according to the following equation:

$${l}_{f , k + 1} = {l}_{f , k} + {g}_{k} ( \frac{( {\dot{y}}_{c} - {ψ}_{c} {v}_{x} ) L}{{v}_{x} δ} - {l}_{f , k} )$$

where gₖ is an adaptive gain filter.

At block 314, the processing system 102 updates the motion estimation for the vehicle 100 and trailer 301 based on the CG location 302 determined at block 312. This update ensures that the perception task engine 212 and/or the ADAS 214 have accurate data for making real-time adjustments for controlling the vehicle 100.

At block 316, the processing system 102 updates a tongue load calculation and robust lateral controls for the vehicle 100 and trailer 301. This involves adjusting the load distribution and lateral stability controls to accommodate the CG location 302.

At block 318, the processing system 102 notifies the driver of the vehicle 100 of any load displacement. This notification provides the driver with information about changes in load distribution that may affect vehicle handling.

At block 320, the processing system 102 updates the ADAS control with the new center of gravity location. This update allows the advanced driver assistance systems to utilize the most current data for vehicle control, enhancing safety and performance.

FIG. 4 illustrates a schematic diagram of a system 400 for camera-based estimation of vehicle center of gravity for model-based vehicle control according to one or more embodiments.

The system 400 can be implemented by the processing system 102 of FIGS. 1 and 2, which receives inputs from various sensors (e.g., the camera 104) and performs calculations to estimate the center of gravity location of the vehicle 100. The system 400 includes a load location learn block 402, which includes enablement criteria 404 and a learning and adaptive filter 412.

The load location learn block 402 processes inputs from the FCM 422, the WSS 424, and the SAS 426. These inputs include lane markings, wheel speeds, and steering angle, which are used for determining the dynamics of the vehicle 100.

The enablement criteria 404 evaluates conditions for the load location learning process. This includes performing an excitation check 406, an error variance check 408, and a velocity check 410 to ensure that the data is suitable for further processing. For example, the excitation check 406 looks at a prediction from the model and a measured value to identify a difference to get meaningful information to update the learning and adaptive filter 412. The error variance check 408 determines how much the error (e.g., the error in prediction and measurement) is changing in a time window (e.g., is the error growing higher or growing lower), where the error is indicated by the following equation, set forth above:

$$\frac{( {\dot{y}}_{c} - {ψ}_{c} {v}_{x} ) L}{{v}_{x} δ} - {l}_{f , k} .$$

The velocity check 410 determines the velocity of the vehicle 100.

The learning and adaptive filter 412 refines the estimation process. The vision based velocity estimation 414 calculates the lateral velocity of the vehicle 100 as described herein. The prediction model 416 predicts the CG location 302 of the vehicle 100. The prediction error calculation block 418 assesses the accuracy of the predictions. The statistical filter 420 processes the prediction errors to improve the reliability of the center of gravity estimation.

The calibration block 428 sets an initial CG location value (e.g., set by the manufacturer) particular to the vehicle 100. This initial CG location value is adjusted in accordance with one or more of the embodiments described herein to determine the CG location 302 based on changes in loads and configurations (e.g., attached trailer) of the vehicle 100.

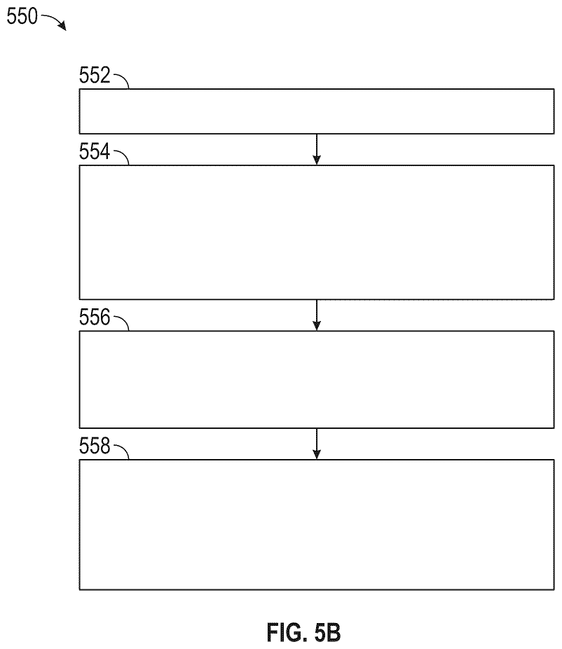

FIG. 5A illustrates a flow diagram of a method 500 for camera-based estimation of vehicle center of gravity for model-based vehicle control according to one or more embodiments. The method 500 can be implemented using any suitable system or device. For example, the method 500, and its steps, can be implemented using the processing system 102 of FIGS. 1 and 2, by the processing system 600 of FIG. 6, and/or the like, including combinations and/or multiples thereof. The method 500 is now described with reference to at least portions of FIGS. 1-4 but is not so limited.

The method 500 involves several steps to predict and adjust the dynamics and control of the vehicle 100.

At block 502, the method 500 predicts the hitch angle of the trailer. This prediction utilizes data from the trailer wheelbase and center of gravity 520, as well as inputs from the FCM 422, map 524, and inertial measurement unit (IMU) 526.

At block 504, the method 500 constructs predictive articulated dynamics using a CG location estimation from block 505. This step involves using the predicted hitch angle to model the dynamic behavior of the trailer and vehicle system (e.g., the vehicle 100 with the trailer 301).

At block 506, the method 500 predicts the lateral offset of the trailer at a look-ahead distance. This prediction helps in understanding the trailer's position relative to the vehicle's path.

At block 508, the method 500 adjusts the vehicle to position the trailer correctly. This adjustment ensures that the trailer remains aligned with the intended path of the vehicle.

At block 510, the method 500 prevents trailer departure from the intended path. This step involves implementing control measures to keep the trailer within the designated lane.

At block 512, the method 500 performs lateral control. This control maintains the vehicle and trailer's stability and alignment during movement.

At block 514, the method 500 issues a trailer lane departure warning. This warning alerts the driver or autonomous system if the trailer begins to deviate from the intended lane.

Additional processes also may be included, and it should be understood that the processes depicted in FIG. 5A represent illustrations, and that other processes may be added, or existing processes may be removed, modified, or rearranged without departing from the scope of the present disclosure. It should also be understood that the processes depicted in FIG. 5A may be implemented as programmatic instructions stored on a non-transitory computer-readable storage medium that, when executed by a processor (e.g., the processing device 202 of FIG. 2, the processor(s) 621 of FIG. 6, and/or the like, including combinations and/or multiples thereof) of a computing system (e.g., the processing system 102 of FIGS. 1 and 2, the processing system 600 of FIG. 6, and/or the like, including combinations and/or multiples thereof), cause the processor to perform the processes described herein.

FIG. 5B illustrates a flow diagram of a method 550 for camera-based estimation of vehicle center of gravity for model-based vehicle control according to one or more embodiments. The method 550 can be implemented using any suitable system or device. For example, the method 550, and its steps, can be implemented using the processing system 102 of FIGS. 1 and 2, by the processing system 600 of FIG. 6, and/or the like, including combinations and/or multiples thereof. The method 500 is now described with reference to at least portions of FIGS. 1-4 but is not so limited.

At block 552, the method 550 begins with the processing system 102 receiving an image (e.g., one or more of the images 211 captured by the camera 104).

At block 554, the CG engine 210 determines, using the image, a relative position and pose of the vehicle 100 relative to a lane marking of a lane (e.g., the lane 306) of a road occupied by the vehicle 100 and in which the vehicle 100 is traveling.

At block 556, the CG engine 210 determines a relative center of gravity location of the vehicle 100 based at least in part on the relative position and pose of the vehicle 100 determined at block 554.

Finally, at block 558, the ADAS 214 controls the vehicle 100 based on a model of the vehicle 100 that utilizes the relative center of gravity location of the vehicle determined at block 556.

According to one or more embodiments, controlling the vehicle 100 can include performing a perception task is performed by the perception task engine 212 using the image from the camera 104 and the model of the vehicle 100 that utilizes the center of gravity location that is determined at block 556. More particularly, a perception task is performed using the aggregated radar data of the target object aggregated for the period of time specific to the reflection point as defined by the dynamic aggregation duration. Perception tasks, as performed by the perception task engine 212, involve processing the images (e.g., images captured by the camera 104) to detect, classify, and track objects in the environment of the vehicle 100, for example. These tasks are useful for providing real-time awareness, enabling the vehicle 100 to make informed decisions and to operate efficiently. For example, in autonomous driving, perception tasks help identify obstacles, road signs, and other vehicles, allowing for efficient navigation. The perception task engine 212 integrates data collected by the camera 104 and the model of the vehicle 100 that utilizes the center of gravity location determined at block 556 to enhance the accuracy and reliability of these perception tasks.

Additional processes also may be included, and it should be understood that the processes depicted in FIG. 5B represent illustrations, and that other processes may be added, or existing processes may be removed, modified, or rearranged without departing from the scope of the present disclosure. It should also be understood that the processes depicted in FIG. 5B may be implemented as programmatic instructions stored on a non-transitory computer-readable storage medium that, when executed by a processor (e.g., the processing device 202 of FIG. 2, the processor(s) 621 of FIG. 6, and/or the like, including combinations and/or multiples thereof) of a computing system (e.g., the processing system 102 of FIGS. 1 and 2, the processing system 600 of FIG. 6, and/or the like, including combinations and/or multiples thereof), cause the processor to perform the processes described herein.

One or more embodiments of the camera-based estimation of vehicle center of gravity for model-based vehicle control offer significant technical improvements and benefits, as follows.

One or more embodiments provides enhanced vehicle stability and control. For example, by accurately estimating the center of gravity location of the vehicle, the system can improve the stability and control of the vehicle. This is particularly useful for vehicles towing trailers, where the CG can shift and affect handling. The accurate CG estimation allows for better control algorithms, leading to safer and more stable driving experiences.

One or more embodiments provides improved advanced driver assistance systems. For example, one or more embodiments enhances the performance of various ADAS features, such as automated lane change, front collision alert, collision imminent braking, and automated evasive steering. By utilizing the accurate CG location in the vehicle model, these systems can make more informed decisions, resulting in more effective and reliable assistance to the driver.

One or more embodiments provides real-time load displacement detection. For example, one or more embodiments can generate alerts indicating load displacement based on the relative CG location. This is particularly useful for vehicles carrying varying loads or towing trailers, as it provides real-time feedback to the driver about changes in load distribution that may affect vehicle handling.

One or more embodiments provides robustness to model uncertainty. For example, one or more embodiments includes a control robustness strategy to adjust the CG location of the vehicle and trailer. This ensures that the vehicle control remains effective even in the presence of model uncertainties or changes in the vehicle's load configuration.

One or more embodiments provides systematic learning and adaptation. For example, one or more embodiments features an estimator excitation monitor that systematically calculates the required contextual conditions to learn the CG location. The estimator updates the parameters to correct for suboptimal CG locations, ensuring continuous improvement and adaptation to changing conditions.

One or more embodiments provide integration with perception tasks. For example, one or more embodiments leverages camera-based perception data to estimate the CG location. This integration allows for more accurate and reliable perception tasks, such as object detection, classification, and tracking, which are essential for autonomous and semi-autonomous driving.

One or more embodiments provides versatility across different vehicle types. For example, one or more embodiments can be applied to various types of vehicles, including cars, trucks, vans, buses, motorcycles, boats, and more. It is also adaptable to different vehicle configurations, such as those with trailers, making it a versatile solution for a wide range of applications.

One or more embodiments provides enhanced reliability and performance. For example, by providing accurate CG location data and improving the performance of ADAS features, one or more embodiment enhances the overall reliability and performance of the vehicle. This leads to a more comfortable and secure driving experience for the operator and passengers.

Overall, the embodiments described herein provide a comprehensive solution for improving vehicle control and safety through accurate estimation and utilization of the vehicle's center of gravity location.

It is understood that one or more embodiments described herein is capable of being implemented in conjunction with any other type of computing environment now known or later developed. For example, FIG. 6 depicts a block diagram of a processing system 600 for implementing the techniques described herein. In accordance with one or more embodiments described herein, the processing system 600 is an example of a cloud computing node of a cloud computing environment. In examples, processing system 600 has one or more central processing units (referred to also as “processors” or “processing resources” or “processing devices”) 621a, 621b, 621c, etc. (collectively or generically referred to as processor(s) 621 and/or as processing device(s) 621). In aspects of the present disclosure, each processor 621 can include a reduced instruction set computer (RISC) microprocessor. Processors 621 are coupled to a system memory 622 and/or various other components via a system bus 633. The system memory 622 can include one or more temporary and/or persistent memory devices, such as a random access memory (RAM) 623, a read-only memory (ROM) 624, and/or the like, including combinations and/or multiples thereof. The system bus 633 may include a basic input/output system (BIOS), which controls certain basic functions of processing system 600.

Further depicted are an input/output (I/O) adapter 627 and a network adapter 626 coupled to system bus 633. I/O adapter 627 may be a small computer system interface (SCSI) adapter that communicates with a hard disk 635 and/or a storage device 636 or any other similar component. I/O adapter 627, hard disk 635, and storage device 636 are collectively referred to herein as mass storage 634. Operating system 640 for execution on processing system 600 may be stored in mass storage 634. The network adapter 626 interconnects system bus 633 with an outside network 638 enabling processing system 600 to communicate with other such systems.

A display (e.g., a display monitor) 639 is connected to system bus 633 by display adapter 632, which may include a graphics adapter to improve the performance of graphics intensive applications and a video controller. In one aspect of the present disclosure, adapters 626, 627, and/or 632 may be connected to one or more I/O buses that are connected to system bus 633 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 633 via user interface adapter 628 and display adapter 632. A keyboard 629, mouse 630, and speaker 631 may be interconnected to system bus 633 via user interface adapter 628, which may include, for example, a Super I/O chip integrating multiple device adapters into a single integrated circuit.

In some aspects of the present disclosure, processing system 600 includes a graphics processing unit (GPU) 637. Graphics processing unit 637 is a specialized electronic circuit designed to manipulate and alter memory to accelerate the creation of images in a frame buffer intended for output to a display. In general, graphics processing unit 637 is very efficient at manipulating computer graphics and image processing and has a highly parallel structure that makes it more effective than general-purpose CPUs for algorithms where processing of large blocks of data is done in parallel.

Thus, as configured herein, processing system 600 includes processing capability in the form of processors 621, storage capability including the system memory 622 and mass storage 634, input means such as keyboard 625 and mouse 630, and output capability including speaker 631 and display 639. In some aspects of the present disclosure, a portion of system memory 622 and mass storage 634 collectively store the operating system 640 to coordinate the functions of the various components shown in processing system 600.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A computer-implemented method comprising:
receiving an image from a camera of a vehicle;
determining, using the image, a relative position and pose of the vehicle relative to a lane marking of a lane of a road occupied by the vehicle and in which the vehicle is traveling;
determining a relative center of gravity location of the vehicle based at least in part on the relative position and pose of the vehicle; and
controlling the vehicle using an advanced driver assistance system based on a model of the vehicle, wherein the model utilizes the relative center of gravity location of the vehicle.

2. The computer-implemented method of claim 1, wherein the vehicle is mechanically coupled to a trailer, and wherein the relative center of gravity location of the vehicle is based at least in part on the trailer.

3. The computer-implemented method of claim 1, wherein the advanced driver assistance system is an automated lane change system to cause the vehicle to perform a lane change.

4. The computer-implemented method of claim 1, wherein the advanced driver assistance system is a front collision alert system to generate an alert to an operator of the vehicle warning of a potential front collision.

5. The computer-implemented method of claim 1, further comprising generating an alert indicating a load displacement based at least in part on the relative center of gravity location of the vehicle.

6. The computer-implemented method of claim 1, wherein the advanced driver assistance system is a collision imminent braking system to apply brakes of the vehicle to reduce a velocity of the vehicle.

7. The computer-implemented method of claim 1, wherein the advanced driver assistance system is an automated evasive steering system to adjust a trajectory of the vehicle.

8. The computer-implemented method of claim 1, wherein controlling the vehicle comprises performing a perception task using at least the image and the model of the vehicle that utilizes the relative center of gravity location of the vehicle.

9. The computer-implemented method of claim 1, wherein the relative center of gravity location of the vehicle is determined using the following equation:
$${l}_{f} = \frac{( {\dot{y}}_{c} - {ψ}_{c} {v}_{x} ) L}{{v}_{x} δ}$$
where \dot{y}_{c} is a relative position to the lane marking, ψ_{c} is a relative heading of the vehicle to the lane marking, δ is a front road wheel angle of the vehicle, vₓ is a longitudinal velocity of the vehicle, L is a wheelbase of the vehicle determined by l_{f}+lᵣ, l_{f} is a distance of the relative center of gravity location to a front axle of the vehicle, and lᵣ is a distance of the relative center of gravity location to a rear axle of the vehicle.

10. The computer-implemented method of claim 9, wherein, responsive to the vehicle being mechanically coupled to a trailer, a lateral velocity of the vehicle v_{y,c} is determined using the following equation:
$${v}_{y , c} = {v}_{x} δ \frac{{l}_{f}}{L} + {v}_{x} {θ}_{h} \frac{{l}_{t}}{{L}_{t}}$$
where θₕ is a hitch angle of the trailer relative to the vehicle.

11. A vehicle mechanically coupled to a trailer, the vehicle comprising:
a hitch for mechanically coupling the vehicle to the trailer;
a camera; and
a processing system comprising:
a memory comprising computer readable instructions; and
a processing device for executing the computer readable instructions, the computer readable instructions controlling the processing system to perform operations comprising:
receiving an image from the camera;
determining, using the image, a relative position and pose of the vehicle and trailer relative to a lane marking of a lane of a road occupied by the vehicle and trailer and in which the vehicle and trailer are traveling;
determining a relative center of gravity location of the vehicle and trailer based at least in part on the relative position and pose of the vehicle and trailer; and
controlling the vehicle using an advanced driver assistance system based on a model of the vehicle and trailer, wherein the model utilizes the relative center of gravity location of the vehicle and trailer.

12. The vehicle of claim 11, wherein the advanced driver assistance system is an automated lane change system to cause the vehicle to perform a lane change.

13. The vehicle of claim 11, wherein the advanced driver assistance system is a front collision alert system to generate an alert to an operator of the vehicle warning of a potential front collision.

14. The vehicle of claim 11, wherein the advanced driver assistance system is a collision imminent braking system to apply brakes of the vehicle to reduce a velocity of the vehicle.

15. The vehicle of claim 11, wherein the advanced driver assistance system is an automated evasive steering system to adjust a trajectory of the vehicle.

16. The vehicle of claim 11, wherein controlling the vehicle comprises performing a perception task using at least the image and the model of the vehicle that utilizes the relative center of gravity location of the vehicle.

17. The vehicle of claim 11, wherein the relative center of gravity location of the vehicle is determined using the following equation:
$${l}_{f} = \frac{( {\dot{y}}_{c} - {ψ}_{c} {v}_{x} ) L}{{v}_{x} δ}$$
where \dot{y}_{c} is a relative position to the lane marking, ψ_{c} is a relative heading of the vehicle to the lane marking, δ is a front road wheel angle of the vehicle, vₓ is a longitudinal velocity of the vehicle, L is a wheelbase of the vehicle determined by l_{f}+lᵣ, l_{f} is a distance of the relative center of gravity location to a front axle of the vehicle, and lᵣ is a distance of the relative center of gravity location to a rear axle of the vehicle.

18. The vehicle of claim 17, wherein, responsive to the vehicle being mechanically coupled to a trailer, a lateral velocity of the vehicle v_{y,c} is determined using the following equation:
$${v}_{y , c} = {v}_{x} δ \frac{{l}_{f}}{L} + {v}_{x} {θ}_{h} \frac{{l}_{t}}{{L}_{t}}$$
where θₕ is a hitch angle of the trailer relative to the vehicle.

19. A computer program product comprising:
a set of one or more computer-readable storage media;
program instructions, collectively stored in the set of one or more storage media, for causing a processor set to perform computer operations comprising:
receiving an image from a camera of a vehicle;
determining, using the image, a relative position and pose of the vehicle relative to a lane marking of a lane of a road occupied by the vehicle and in which the vehicle is traveling;
determining a relative center of gravity location of the vehicle based at least in part on the relative position and pose of the vehicle; and
controlling the vehicle using an advanced driver assistance system based on a model of the vehicle, wherein the model utilizes the relative center of gravity location of the vehicle.

20. The computer program product of claim 19, wherein the relative center of gravity location of the vehicle is determined using the following equation:
$${l}_{f} = \frac{( {\dot{y}}_{c} - {ψ}_{c} {v}_{x} ) L}{{v}_{x} δ}$$
where \dot{y}_{c} is a relative position to the lane marking, ψ_{c} is a relative heading of the vehicle to the lane marking, δ is a front road wheel angle of the vehicle, vₓ is a longitudinal velocity of the vehicle, L is a wheelbase of the vehicle determined by l_{f}+lᵣ, l_{f} is a distance of the relative center of gravity location to a front axle of the vehicle, and lᵣ is a distance of the relative center of gravity location to a rear axle of the vehicle, and
wherein, responsive to the vehicle being mechanically coupled to a trailer, a lateral velocity of the vehicle v_{y,c} is determined using the following equation:
$${v}_{y , c} = {v}_{x} δ \frac{{l}_{f}}{L} + {v}_{x} {θ}_{h} \frac{{l}_{t}}{{L}_{t}}$$
where θₕ is a hitch angle of the trailer relative to the vehicle.
